(19) United States
(12) Patent Application Publication
(10) Pub. No.: US 2004/0163693 A1
(43) Pub. Date: Aug. 26, 2004

(54) Innovative handle grip for walking stick

(75) Inventor: S. Uemura, Nagoya (JP)

Correspondence Address: BACON & THOMAS, PLLC, 625 SLATERS LANE, FOURTH FLOOR, ALEXANDRIA, VA, 22314

(73) Assignee: CRYSTAL INDUSTRIAL CO., LTD., Nagoya (JP)

(21) Appl. No.: 10/372,305

(22) Filed: Feb. 25, 2003

(51) Int. Cl. A61H 3/02

(52) U.S. Cl. 135/72

(57) ABSTRACT

This invention provides an innovative handle grip for the walking stick, in particular the wrist strap that is easy for adjustment in length and the handle grip itself is easy to construct. The wrist strap has one end passing the buckle to form a loop and the other end is fastened in the cavity on the side of the handle grip. The buckle strap has two perforations and one central brace to support one end of the wrist strap and a brake to limit the movement of the strap.

### FIELD OF THE INVENTION

This invention relates to an innovative handle grip for the walking stick; more precisely, it is a special handle grip equipped with a wrist strap, easy for adjusting the length of the loop and convenient for use.

### BACKGROUND OF THE INVENTION

In the prior art of the handle grip for a walking stick, the main purpose to equip the adjustable handle grip is to provide the user a firm hold of a walking stick. The wrist strap 101 as shown in FIG. 7 includes a strap loop 104 having one end 104a linked to the buckle 105, the other end 104b extended out of the buckle 105 and the rest part forming a loop 110. In the meantime, the central part of the loop 110 is folded into a fastener 115 and fixed by a fastener 116 on one side of the handle grip 103.

In case the user intends to adjust the length of the loop 110, it is necessary to release the restraint the buckle 105 has imposed on the loop 110. And then, pull the end 104b of the strap loop 104 a little bit out of the buckle 105 to adjust the length of the strap loop 104.

However, it is apparent that there exist in the wrist strap 101 many problems. One of which is to relax the restraint the buckle 105 imposes on the strap loop 104 so to make the adjustment possible by pulling the end 104b of the strap loop out. After the length adjustment, the strap loop 104 is held still by the buckle 105. In other word, the user is required to perform three actions to adjust the length of the wrist strap 101, which is rather complicated and inconvenient for operation.

Furthermore, the walking sticks are mainly used by the old man or handicapped persons whose fingers are dull. It is in fact hard for them to adjust the length of the loop 110 for the strap loop 104.

In another circumstance, if the user is wearing cold-protective gloves, such as in winter skiing, the thick gloves the user wears will make the length adjustment very difficult; particularly in severely cold weather, the wrist strap 104 and the buckle 105 are more than often frozen together, making the length adjustment impossible unless the skier takes off the gloves, so doing would incite a risk of frostbite.

### SUMMARY OF THE INVENTION

Aiming at solving such problems mentioned above, this invention is to provide an easy adjustable handle grip.

The main object of this invention is to provide an easy finger touch adjustment between the strap loop and the buckle, convenient for the glove wearer, the handicapped or old men with dull fingers to make adequate length adjustment of the strap loop with a single hand.

This invention is also applicable to the skiing stick, walking stick and mountain climbing stick.

### BRIEF DESCRIPTION OF THE INVENTION

This invention has an easy finger touch adjustment on the bucket, permitting effortless length adjustment of the strap loop, even for the old men and the handicapped that have weak holding power as well as the ones wearing thick gloves.

As the prior art of the handle grip, the fixture of wrist strap is a very simple installation with low cost in manufacture.

The buckle provided in this invention has two perforations and one central brace. It is really a simple buckle, very popularly used on the wrist strap with simple production and low cost.

The buckle provides a brake to confine the strap loop in a desirable range but permitting for easy adjustment by the finger touch.

The brake is outfitted with a sound alarm to draw attention of others.

The brake is also permitted to hook up on the top with an identification label to illustrate who the user is and where his residence is.

One end of the strap loop forms two loose brakes and two small loops around the buckle, and the end tail of the strap loop is fixed on the loose brake.

It is a simply constructed and low cost walking stick for travelers.

### BRIEF DESCRIPTION OF THE DRAWINGS

FIG. 1 shows a complete stereo of and partial schematic diagram of a handle grip of the invention.

FIG. 2 shows a passage of a wrist strap through a buckle.

FIG. 3 is a cross-section of a buckle as shown in FIG. 2.

FIG. 4a and 4b show a passage of a wrist strap through a buckle.

FIG. 5 is another embodiment to fix a wrist strap to a handle grip.

FIG. 6 is another embodiment to fix a wrist strap to a handle grip.

FIG. 7 is a prior art of a handle grip.

### DETAILED DESCRIPTION OF THE PREFERRED EMBODIMENT

This invention is explained in great details with the aid of the embodiments as illustrated in the drawings.

(1) Construction of Walking Stick

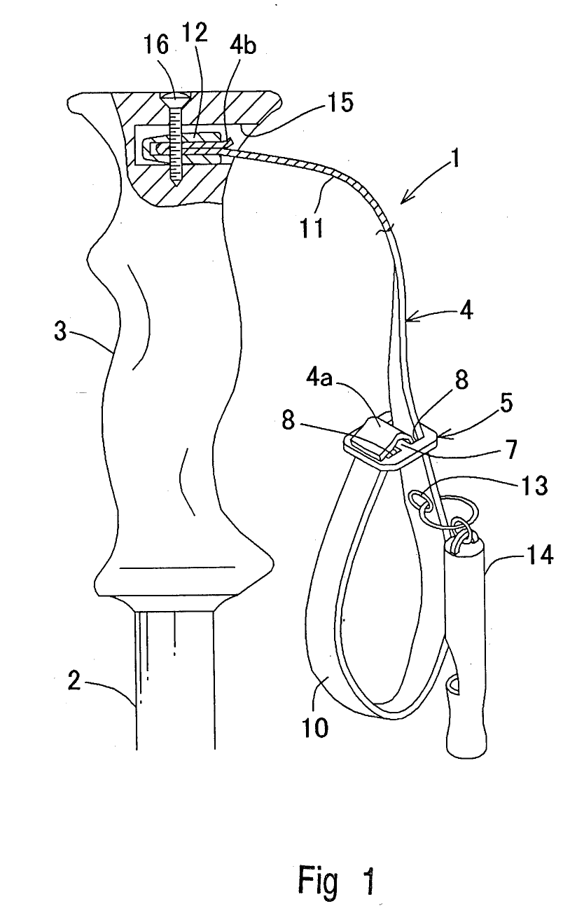

As shown FIG. 1, the walking stick 1 comprises a shank 2, a handle grip 3, wrist strap 4 and a buckle 5.

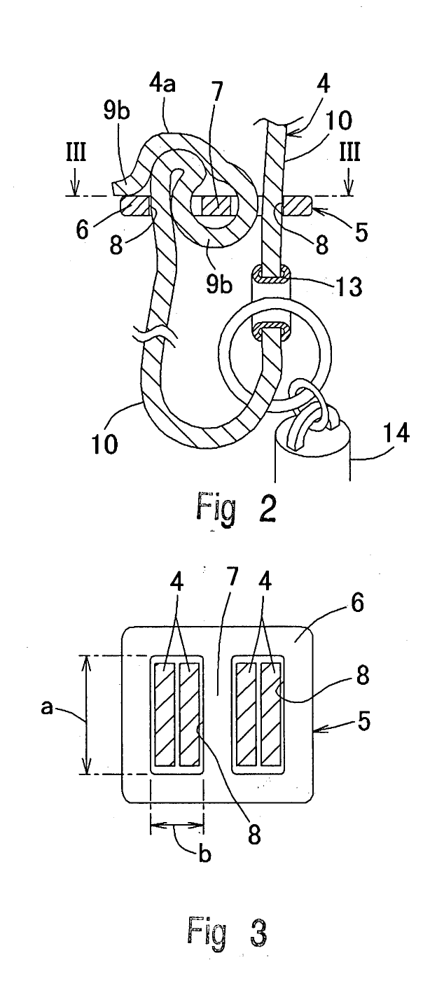

The buckle 5 as shown in FIGS. 2 and 3 has a square outer frame 6 and central brace 7 to form two perforations 8 between the outer frame 6 and central brace 7. The vertical distance of the perforations is identical to the width a of the strap and the width b of the perforation equals to the thickness of two straps to pass through and to permit compressive length adjustment of the loop 10 with the buckle 5.

The central brace 7 of the buckle 5 permits the end tail 9a on the end 4a of the wrist strap 4 to form an end tail 9b fixed on the outer frame 6 by ultrasonic wave welding. The other end 4b will pass the perforation 8 to form a big loop 10 as shown in FIG. 2. A proper length adjustment can be made with the perforation 8 of the buckle 5 as shown in FIG. 1. The other end 4b of the loop 10 is fixed on the plastic-formed cavity 12.

The loop 10 provides a ring brake 13 at an appropriate position with a diameter a little bigger than the perforation 8, which will not allow the brake 13 to pass. The ring brake 13 permits to hang a sound whistle, and it also allows the user to take off the wrist strap easily.

(2) Manipulation of the Handle Grip

In physical operation of the handle grip 3 of the walking stick 1, the user extends his wrist into the loop 10 of the wrist strap 4 with one finger to hold the buckle 5 and other finger to carry out the length adjustment of the loop 10 of the wrist strap 4 to secure the most optimal hold length of the loop 10, then hold the handle grip 3 with the loop 10 enclosed on his wrist.

(3) Efficacy of the Embodiment

The walking stick as discussed in the Section (1) above, where it is easy to adjust the length of the loop 10 of the wrist strap 4 by slightly pressing the finger tip only, therefore requiring no great effort to make such length adjustment of loop 10 of the wrist strap 4 by the user who has weak holding force and who wears thick gloves.

The distance between the buckle 5 and the brake 13 is limited so the length permitted to adjust is limited too. The length adjustment is to provide sufficient room for the user to insert his hand into the loop 10.

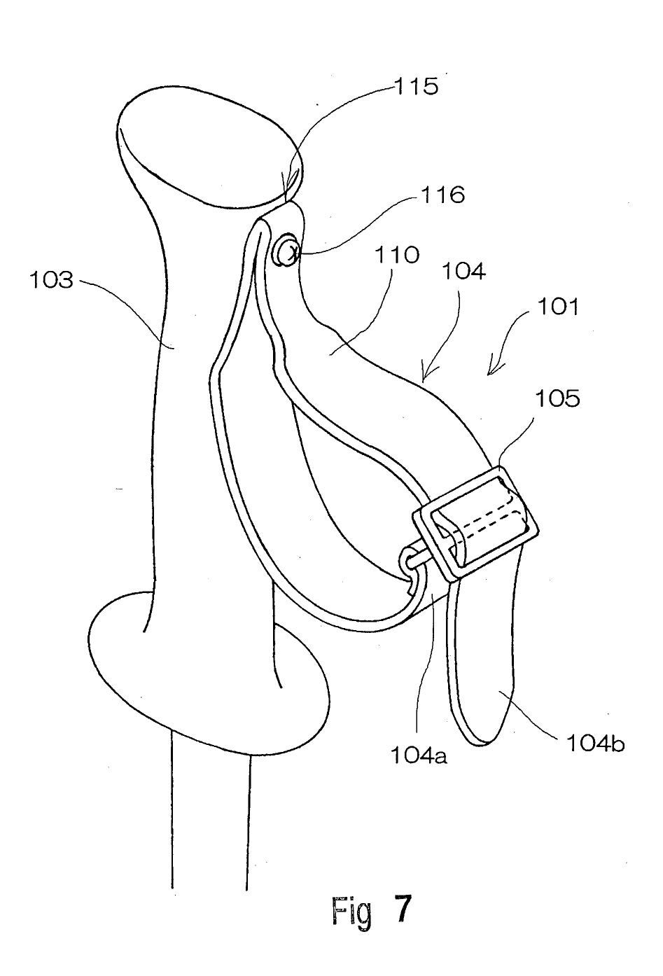

The walking stick 1 as discussed in Section (1) and as shown in FIG. 7, the handle grip 103 is designed to attach with a fastening ring 110 and the distance between the buckle 105 and the fastening ring 110 is really too short. It is easy to produce an entanglement, which would be likely to hurt the user's hand when he incidentally twists the walking stick 1. It differs greatly in the embodiment as shown in FIG. 1, in which one end of the handle grip 3 is in the form of a section of cord 11, keeping enough distance from the loop 10. In case of twisting, the user's hand would bear a great load; the loop 10 of the wrist strap 4 will never be deformed to render hurt to the hand.

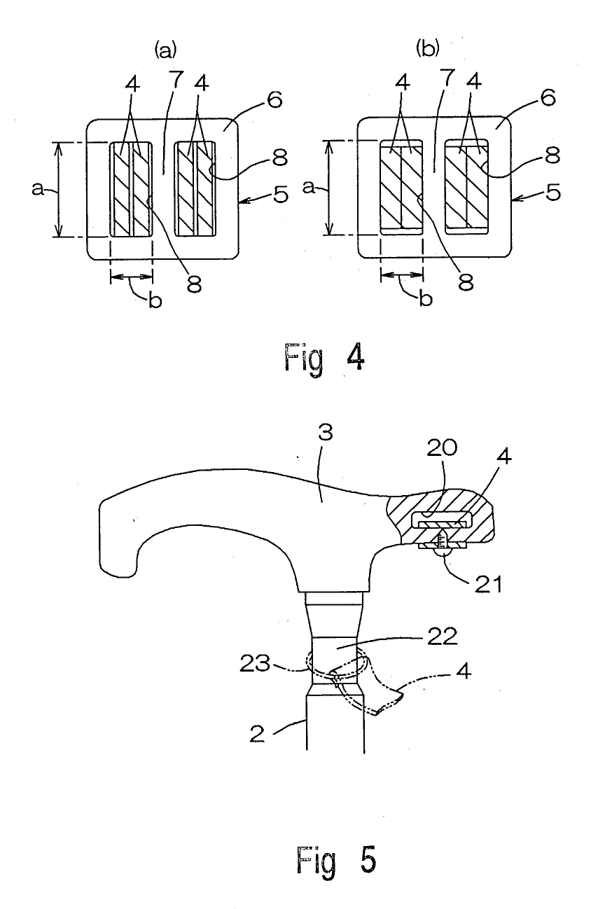

The illustrative embodiment of this invention exemplifies the advantages and objects; other embodiments, which follow, shall be included in the scope of this invention. The perforations 8 of the buckle 5 are designed exclusively to release or to restrain the length of the loop 10. The perforations 8 produce commensurate friction and resistance for the loop 10. As shown in FIG. 4, the vertical gap a of the perforations 8 permit the passage of the wrist strap 4 whose width is identical to or smaller than that of the vertical gap a, and the horizontal gap b of the perforations 8 accommodates the thickness of two straps of the wrist strap 4 or less.

The cavity 15 on the handle grip 3 as shown in FIG. 5 can be applied to various designs of the handle grip 3, in which a perforation 20 is formed and the end tail of the wrist strap is locked in place by a screw 21. Another design is that a tapered section 22 is made between the handle grip 3 and the shank 2 and a lock ring 23 is provided to hold the wrist strap 4 as the dotted line indicates.

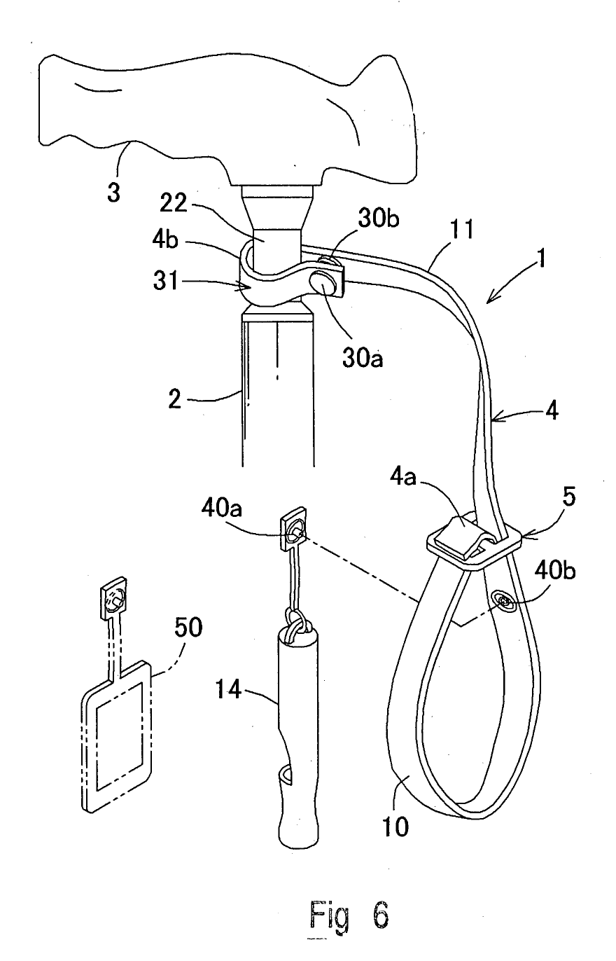

As shown in FIG. 6, the other end 4b of the wrist strap 4 forms a small loop 31 to enclose the tapered section 22 to be locked or unlocked by the snaps 30a and 30b.

The brake 13 can be made some modification as shown in FIG. 6; a whistle 14 is locked up or unlocked from the wrist strap 4 by snaps 40a and 40b. It is easy to separate the whistle 14 from the wrist strap 4.

In addition, the whistle 14 can be in any form. As the dotted lines shown in FIG. 6, it can be nametag 50 along with addresses used in case of missing.

Viewing from the above statements, it is apparent that the wrist strap of the handle grip provides easy length adjustment, which is an innovation and improvement from the prior art, and these designs have never been appeared on the publication to the public, thus are sufficiently justified for a grant of a new patent.

What is claimed is:

1. A handle grip for a walking stick, having an adjustable wrist strap having one end passing a buckle to be fixed thereon and other end passing said buckle to form a strap loop and finally locked up in cavity of said handle grip.

2. The handle grip for a walking stick of claim 1, wherein said buckle consists of two perforations and a central brace, and a loop is formed on said central brace.

3. The handle grip for a walking stick of claim 1, wherein a brake is provided to confine a size of said loop.

4. The handle grip for a walking stick of claim 1, wherein a whistle is hung on said loop.

5. The handle grip for a walking stick of claim 1, wherein said whistle can be changed to be a nametag with an indication of user's name and address.

6. The handle grip for a walking stick of claim 1, wherein said handle grip is good for use on the traveler's walking stick.
